(19) United States
(12) Patent Application Publication
(10) Pub. No.: US 2024/0416303 A1
(43) Pub. Date: Dec. 19, 2024

(54) FLUID TREATMENT SYSTEM AND RELATED METHODS

(71) Applicant: LignoSol Ip Limited, San Gwann (MT)

(72) Inventors: Desmond Alexander SOMERVILLE, San Gwann (MT); Patrick WAIBEL, San Gwann (MT)

(21) Appl. No.: 18/708,275

(22) PCT Filed: Sep. 27, 2022
(86) PCT No.: PCT/IB2022/059176

§ 371 Date: May 8, 2024

(30) Foreign Application Priority Data
Nov. 18, 2021 (GB) 2116007.2

(51) Int. Cl. B01F 33/82; B01F 23/231; B01F 25/4314; C07G 1/00

(52) U.S. Cl. CPC B01F 33/82; B01F 23/231; B01F 25/4314; C07G 1/00

(57) ABSTRACT

A system is provided for treating fluids, such as a composition comprising lignin and/or a hydrocarbon-containing material. The fluid is conditioned in a first treatment apparatus and further treated in a second treatment apparatus comprising a nano-bubble generator to form nano-bubbles in the treated fluid. In some embodiments the system is used to accelerate and/or enhance the separation and recovery of hydrocarbons from a hydrocarbon containing material.

### BACKGROUND OF THE INVENTION

This invention relates to a system for treating a fluid. In some embodiments, the system is used for preparing a lignin-based treatment composition and/or the separation of hydrocarbons from a hydrocarbon-containing material, and related applications and methods.

A large number of different hydrocarbon treatment applications are found, for example, in the oil and gas industry. A myriad of techniques exist for the separation and recovery of hydrocarbons from various hydrocarbon-containing materials, be they particulate hydrocarbon containing materials or liquid hydrocarbon-containing materials, or the like. In the oil and gas industry, the hydrocarbon containing materials include oil sands, as well as natural gas and oil from subterranean reservoirs.

For instance, the use of analogue ionic liquids for the separation of hydrocarbons from particulate matter has been proposed in U.S. Pat. No. 9,447,329. However, the reagents used are costly and may make the process economically infeasible.

### SUMMARY OF THE INVENTION

In one aspect of the invention, there is provided a system for treating a fluid, the system comprising:
a first treatment apparatus comprising an inlet and an outlet and defining a first treatment chamber between the inlet and the outlet, the inlet being in fluid communication with a source of the fluid, the first treatment chamber including means for disturbing the flow profile of fluid received from the source and flowing through the chamber, thereby to condition the fluid for further treatment;
a second treatment apparatus comprising an inlet and an outlet and defining a second treatment chamber between the inlet and the outlet, the inlet being in fluid communication with the first treatment apparatus to receive the conditioned fluid, the second treatment apparatus further comprising a nano-bubble generating device to form nano-bubbles in the fluid as it flows through the second treatment chamber prior to being expelled via the outlet; and
a pump arranged to cause the flow of the fluid through the respective first and second treatment apparatus.

In some embodiments, the first treatment apparatus comprises a static mixer having a helical or spiral element along the length of the first treatment chamber, the element being arranged to create vortices in the flowing fluid. In some embodiments, a helical or spiral groove is cut into the inner surface of the treatment apparatus defining the treatment chamber to create the vortices in the flowing fluid.

In some embodiments of the invention, the fluid is a composition comprising lignin, the system being arranged to prepare a lignin-based treatment composition therefrom.

In some embodiments of the invention, the fluid is a catholyte solution or a composition comprising lignin and a catholyte solution.

In some embodiments of the invention, the fluid is a hydrocarbon-containing material.

In some embodiments, the hydrocarbon-containing material is pre-mixed with a composition comprising lignin, in particular a lignin-based treatment composition that has been treated in a system as defined above.

In some preferred embodiments the lignin-based treatment composition further comprises at least one isolated strain of bacteria capable of producing at least one biosurfactant, prior to being pumped through the respective first and second treatment apparatus.

The invention extends to the use of technical lignin in the system for preparing a lignin-based treatment composition and/or the separation of hydrocarbons from a hydrocarbon-containing material.

The invention also extends to the use of the system in stabilizing or upgrading a catholyte solution.

In some embodiments, the catholyte solution is upgraded prior to blending with the other components of the treatment composition.

In some embodiments, the catholyte solution and other components of the treatment composition and/or the hydrocarbon containing material are blended, and the blended product is run through the treatment system.

The various fluids, in particular the catholyte solution, may be treated for running times varying between 5 min and 5 hours, depending on the particular application.

Other aspects and features of the present invention will become apparent, to those ordinarily skilled in the art, upon review of the following description of specific embodiments of the disclosure.

### BRIEF DESCRIPTION OF THE DRAWINGS

The invention will now be described in more detail, by way of example only, with reference to the accompanying drawings in which:

FIG. 1 is a schematic plan view of an exemplary system for treating a hydrocarbon-containing material, according to some embodiments;

FIG. 2 is a cross-sectional side view of an embodiment of a first treatment apparatus of the treatment system depicted in FIG. 1, marked as treatment zone A;

FIG. 3 is a cross-sectional side view of an embodiment of a second treatment apparatus of the treatment system depicted in FIG. 1, marked as treatment zone B;

FIG. 4 is a side view of a further embodiment of a first treatment apparatus of the treatment system of the invention, including an illustration of the internal features thereof;

FIG. 5 is a perspective view of the first treatment apparatus shown in FIG. 4, further illustrating the internal features of the first treatment apparatus;

FIG. 6 is a partial cross-sectional side view of a further embodiment of a second treatment apparatus of the treatment system of the invention;

FIG. 7 is a perspective view of the second treatment apparatus shown in FIG. 6;

FIG. 8 is an end view of the nano-bubble generator of the second treatment apparatus shown in FIG. 6;

FIG. 9 is a side view of the nano-bubble generator of the second treatment apparatus shown in FIG. 6; and

FIG. 10 is a side view of the nano-bubble generator of the second treatment apparatus shown in FIG. 6, further illustrating the internal features thereof.

### DESCRIPTION OF PREFERRED EMBODIMENTS

The system of the invention is designed for treating fluids, and is particularly suited to preparing lignin-based treatment compositions and/or the separation of hydrocarbons from hydrocarbon-containing materials. For convenience, a system for separating hydrocarbons from a hydrocarbon-containing material is described in more detail below, it being understood that the system may be used for treating a variety of different fluids.

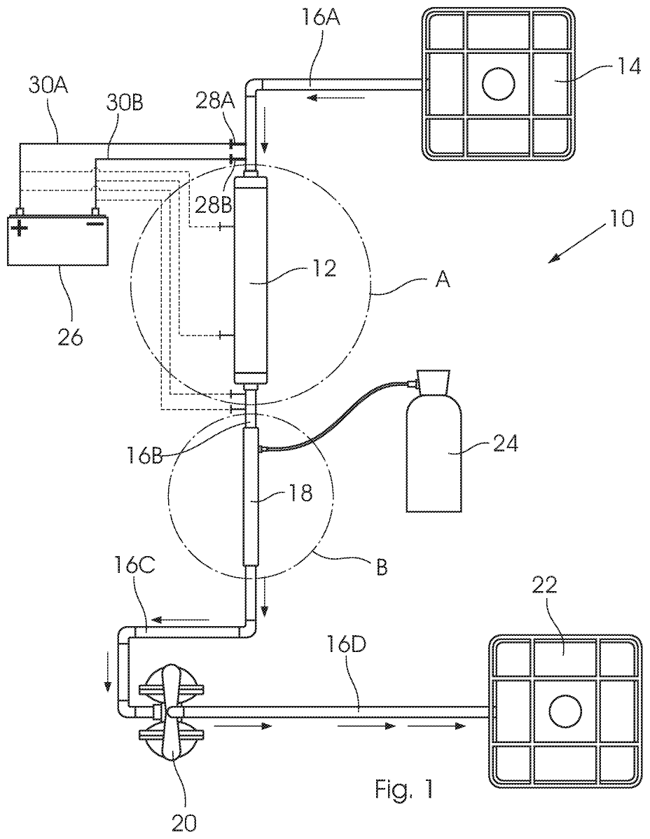

Referring to FIG. 1 of the accompanying drawings, in one embodiment, the treatment system 10 comprises a first treatment apparatus 12, for receiving and treating a hydrocarbon-containing material from a tank or reservoir 14, for example, via an inlet pipe 16A, a second treatment apparatus 18, in fluid communication with the first treatment apparatus 12 via flow pipe 16B, for receiving and further treating the hydrocarbon-containing material, and a pump 20 for moving the hydrocarbon-containing material through the respective treatment apparatus 12 and 18 to a receiving or storage tank 22 via respective outflow pipes 16C and 16D. The second treatment apparatus 18 is preferably designed to introduce gas into the flowing hydrocarbon-material being treated to form nano-bubbles therein, and accordingly the system includes a source of gas 24 for producing the nano-bubbles.

In some embodiments of the invention, an electrical charge can be applied to the hydrocarbon-containing material prior to, during and/or after flowing through the first treatment apparatus 12, essentially providing it with an electrolysis function. In some embodiments of the invention a cell or battery 26 is connected to electrical terminals 28A and 28B, positioned in pipe 16A, via respective leads 30A and 30B. In so doing, direct current (DC), typically pulsed DC, is applied to the hydrocarbon-containing material just prior to entering the first treatment apparatus 12. As shown in dotted lines, the leads 30A and 30B can be arranged such as to provide the current to the flowing material as it passes through the first treatment apparatus 12 and/or as it exits the first treatment apparatus 12. The electrodes can be made of any suitable material, although copper or silver-plated copper are preferred in certain embodiments of the invention.

Although the source of current depicted is a DC cell or battery, it is envisaged that an AC generator or mains electrical supply can also be used in appropriate circumstances, adapted as necessary for electrolysis to take place. It is also envisaged that the current and/or voltage can be varied as required.

By mixing a hydrocarbon-containing material with a lignin-based composition and then passing it through the treatment system 10, the treated material flowing into the receiving or storage tank 22 is separated into its constituent parts. In particular, the hydrocarbons are separated from the rest of the material and can be recovered therefrom. It is to be understood that the system 10 depicted in FIG. 1 is for illustrative purposes only, and many variations and adaptions would be evident to a person skilled in the art, in particular for scaling the system up for industrial applications. For example, although not shown in this exemplary embodiment, the lignin composition can be recovered from the storage tank 22 and recycled back to the tank or reservoir 14 for use in a subsequent treatment cycle.

In some embodiments, the tank 22 may be a rim-flow collection or similar tank that includes one or more additional nano-bubble generators for enhancing the separation and recovery of hydrocarbons therefrom.

An important feature of the invention is that once the hydrocarbon-containing material has been treated in the respective treatment apparatus 12 and 18, care should be taken to mitigate against agitating the treated fluid as it flows through the system 10. Ideally, a consistent diameter or cross-section through the entire system should be maintained to facilitate the flow of the material through the system. To this end, in a preferred embodiment of the invention, the pump 20 is a vacuum pump as it has been found that such a pump provides reduced or limited mixing of the separated hydrocarbons with the other materials to maximize the separation and recovery from tank 22.

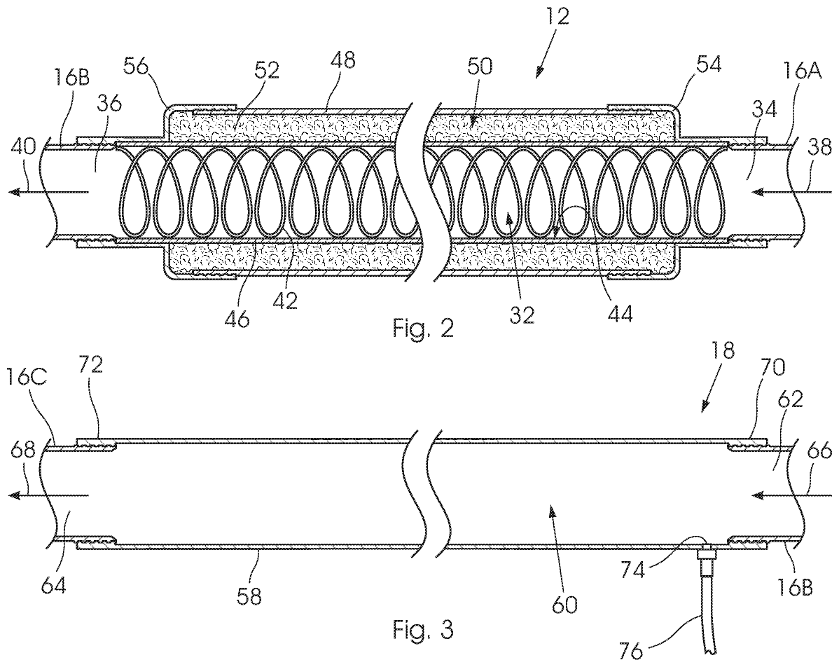

Referring to FIG. 2, an embodiment of the first treatment apparatus 12 (shown in treatment zone A in FIG. 1) comprises a first treatment chamber 32 with an inlet 34 into the chamber 32 and an outlet 36 from the chamber 32. The inlet 34 is in fluid communication with the source of the hydrocarbon-containing material to be treated (not shown) via the flow pipe 16A such that it flows through the chamber in the direction shown by the respective arrows 38, 40. One of the key features of the first treatment apparatus 12 is that it is designed to disturb or change the flow profile of the hydrocarbon-containing material flowing through the treatment chamber 32. For instance, the first treatment apparatus 12 in some embodiments is a static mixer, in particular a tubular mixer in which the treatment chamber 32 is circular in cross-section. In the illustrated embodiment the static mixer 12 includes a helical or spiral element 42 positioned along the length of the chamber 32. In other embodiments, this could be a helical or spiral groove (not shown) cut along the length of the inner wall 44 defining the treatment chamber 32. Whichever arrangement is used, the spiral element 42 or groove (not shown) creates vortices in the flowing hydrocarbon-containing material in order to alter the flow profile thereof and aid to accelerate the action of the lignin-based composition in separation of hydrocarbons from the hydrocarbon-containing material.

In some embodiments of the invention, the helical or spiral element 42 is formed of copper tubing.

In some embodiments, the helical or spiral groove is machined or ‘rifled’ into the inner wall 44.

In this embodiment of the invention, the static mixer 12 comprises a pair of tubular pipes, an inner pipe 46 housing the treatment chamber 32 co-axially located within an outer pipe 48 and defining an annular space 50 between the pipes 46, 48. A particulate mixture 52 of metallic powder or shavings, for example aluminium powder, and crystalline material, such as quartz crystals, for example silica sand, embedded in a resin is sandwiched in the annular space 50 between the pipes 46, 48.

In this embodiment, the inner and outer pipes 46, 48 are coupled to one another and the respective flow pipes 16A and 16B by respective couplings 54 and 56.

Without wishing to be bound by theory, it is believed that the action of disturbing the flow of the hydrocarbon-containing mixture in the presence of the mixture 52 in the first treatment zone A ‘conditions’ the flowing fluid, rendering it suitable for further treatment to enhance the separation of the various components thereof.

Referring to FIG. 3, an embodiment of the second treatment apparatus 18 (shown in treatment zone B in FIG. 1) is a nano-bubble generator 58 having a treatment chamber 60 with an inlet 62 and an outlet 64. The inlet 62 is in fluid communication with conditioned hydrocarbon-containing material flowing from the first treatment apparatus (not shown) via flow pipe 16B such that it flows through the chamber 60 in the direction shown by the respective arrows 66, 68. The nano-bubble generator 58 is connected to respective flow pipes 16B, 16C by respective couplings 70 and 72.

The nano-bubble generator 58, in this embodiment, includes a gas inlet 74 coupled to a source of gas (not shown) via tubing 76, to introduce a gas and form nano-bubbles in the hydrocarbon-containing material as it flows through the second treatment chamber 60, which has been found further to accelerate the lignin-based hydrocarbon-separation process prior to being expelled via the outlet 64. The nano-bubble generator may include various elements or chamber profiles (not shown) for changing the flow path and/or for alternating the pressure profile as the fluid flows through the treatment chamber 60, to enhance the nano-bubble generation process.

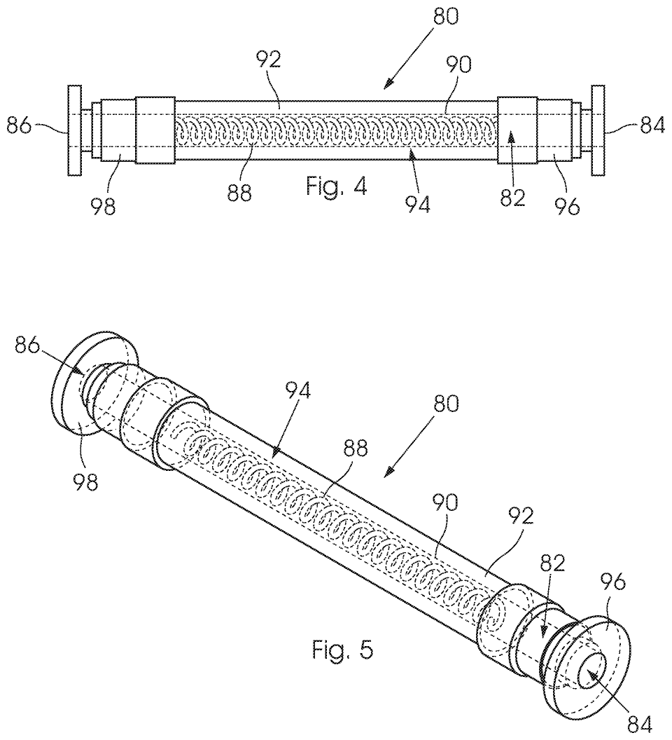

Referring to FIGS. 4 and 5, there is shown a preferred embodiment 80 of the first treatment apparatus shown in treatment zone A in FIG. 1. The treatment apparatus 80 comprises a first treatment chamber 82 with an inlet 84 into the chamber 82 and an outlet 86 from the chamber 82. The inlet 84 is arranged for fluid communication with the source of the hydrocarbon-containing material to be treated (not shown). The first treatment apparatus 80 in this embodiment is a tubular mixer in which the treatment chamber 82 is circular in cross-section and includes a helical or spiral element 88 positioned along the length of the chamber 82. The helical or spiral element 82 creates vortices in the flowing hydrocarbon-containing material in order to alter the flow profile thereof and aid to accelerate the action of the lignin-based composition in separation of hydrocarbons from the hydrocarbon-containing material.

In this embodiment of the invention, the helical or spiral element 88 is formed of copper tubing.

The static mixer 80 comprises a pair of tubular pipes, an inner pipe 90 housing the treatment chamber 82 co-axially located within an outer pipe 92 and defining an annular space 94 between the pipes 90, 92. A particulate mixture of metallic powder or shavings, for example aluminium powder, and crystalline material, such as quartz crystals, for example silica sand, embedded in a resin (not shown) can be sandwiched in the annular space 94 between the pipes 90, 92.

In this embodiment, the inner and outer pipes 90, 92 are coupled to one another by respective couplings 96 and 98.

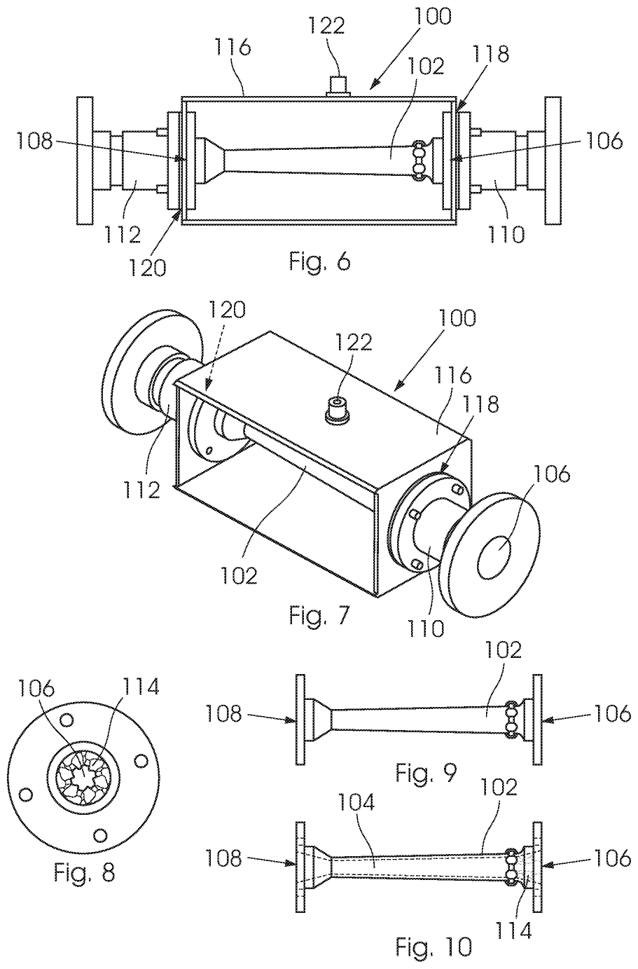

Referring to FIGS. 6 to 10, there is shown a preferred embodiment 100 of the second treatment apparatus shown in treatment zone B in FIG. 1. The treatment apparatus 100 is a nano-bubble generator 102 having a treatment chamber 104 with an inlet 106 and an outlet 108. In this embodiment, the nano-bubble generator 102, and hence the treatment chamber 104, are generally tapered from the inlet 106 towards to the outlet 108. The inlet 106 is arranged to be in fluid communication with conditioned hydrocarbon-containing material flowing from a first treatment apparatus, such as that shown in FIGS. 4 and 5, via an external coupling 110. The outlet 108 is arranged to be in fluid communication with a flow pipe (not shown) via an external coupling 112 for transferring the treated hydrocarbon-containing material to a storage container, for example (not shown).

The nano-bubble generator 102 includes a nano-bubble generating element 114 for changing the flow path and/or for alternating the pressure profile as the fluid flows through the treatment chamber 104, for enhanced nano-bubble generation.

In the embodiment shown, the nano-gas bubble generator 102 is encased in a housing 116, the respective couplings 110, 112 being attached to the respective inlet 118 and outlet 120 ends of the housing 116. The coupling 110 is sized to be connected to the coupling 98 of the treatment apparatus 80 depicted in FIGS. 4 and 5.

The nano-bubble generator 102 includes a gas inlet (not shown) adjacent the inlet 106 and element 114 that is coupled to a source of gas via a port 122 in the housing 116 to introduce a gas to form nano-bubbles in the hydrocarbon-containing material as it flows through the second treatment chamber 104, which has been found further to accelerate the lignin-based hydrocarbon-separation process prior to being expelled via the outlet 108.

In the illustrated embodiments, the material is gasified with nano-bubbles. As used herein, “nano-bubbles” refers to bubbles in the nanometer range i.e. less than 100 nm in diameter.

In some embodiments, prior to forming a suitable fluid the hydrocarbon-containing material comprises hydrocarbon-containing particulate matter. As used herein, “particulate matter” refers to matter comprising solid particles. In some embodiments, the hydrocarbon-containing particulate matter is relatively free of water. In other embodiments, the hydrocarbon-containing particulate matter may comprise at least a portion of water.

The particulate matter may comprise solid particles of materials found in the ground, including but not limited to sand, clay, soil, silt, rock, solid mineral or metal particles, and the like. In other embodiments, the particulate matter may comprise solid particles associated with processing of hydrocarbons, such as metal particles from drilling or process equipment.

In some embodiments, the hydrocarbon-containing material may comprise particulate matter extracted from a subterranean reservoir. As used herein, “reservoir” refers to any subterranean region, in an earth formation, that includes at least one pool or deposit of hydrocarbons therein.

In other embodiments, the particulate matter may comprise soil or other ground material contaminated with at least one hydrocarbon. For example, the particulate matter may comprise soil and/or sand contaminated due to a pipeline leak of crude oil or processed oil in the form of gasoline, or the like. As another example, the particulate matter may comprise soil and/or sand contaminated with natural gas.

In other embodiments, the hydrocarbon-containing material may comprise a hydrocarbon-containing fluid. In some embodiments, the hydrocarbon-containing fluid comprises a multiphase fluid. As used herein, “multiphase fluid” refers to a fluid comprising more than one phase such as a liquid, solid and/or gas phase. In other embodiments, the hydrocarbon-containing fluid may comprise a hydrocarbon-containing liquid that is relatively free of solid material and/or gas.

In some embodiments, the hydrocarbon-containing fluid may comprise an emulsion. For example, the fluid may comprise an oil-water emulsion such as an oil-in-water emulsion or a water-in-oil emulsion. In some embodiments, the emulsion may further comprise at least a portion of particulate matter. As one example, water-in-oil emulsions may be produced during crude oil recovery due to naturally occurring water in the reservoir. Such emulsions may also comprise at least a portion of entrained sand, clay, or the like.

In some embodiments, the hydrocarbon-containing fluid comprises tailings from an oil recovery operation. Conventional oil sands mining operations separate the bitumen from the sand and clay of the oil sands ore using hot or warm water extraction, which produce large volumes of wastewater (i.e. tailings). The tailings are typically stored in large man-made tailings ponds. Tailings from oil sands surface mining operations may comprise a mixture of residual viscous oil (bitumen), salts, suspended solids, and dissolved salts, organics, and minerals.

In other embodiments, the hydrocarbon-containing fluid may comprise drill cuttings from drilling of oil or gas wells. The drill cuttings may comprise solid particulate matter removed from the borehole and brought to the surface in the drilling fluid. The drilling fluid (also called “drilling mud”) may comprise water, a water-based mud (WBM), an oil-based mud (OBM), a synthetic-based mud (SBM) or any other suitable type of mud.

In other embodiments, the hydrocarbon-containing fluid may comprise a liquid contaminated with one or more hydrocarbons. For example, the hydrocarbon-containing liquid may comprise fresh water or seawater contaminated by a crude oil spill, mixtures of oil and water resulting from rinsing of oil tankers or storage facilities, for example.

In other embodiments, the hydrocarbon-containing material may comprise any other suitable material and embodiments are not limited to the specific materials described herein.

In the various embodiments, the hydrocarbon-containing material is treated with a composition comprising lignin, and in some embodiments with at least one strain of bacteria capable of biosurfactant production, prior to being introduced in to the first treatment apparatus 12. In particular, the hydrocarbon-containing material is treated with a lignin-based treatment composition which itself has been prepared in a system of the invention.

As used herein, “lignin” refers to a biopolymer that is found in the secondary cell wall of plants and some algae. Lignin is a complex cross-linked phenolic polymer with high heterogeneity. Typical sources for the lignin include, but are not limited to, softwood, hardwood, and herbaceous plants such as corn stover, bagasse, grass, and straw, for example.

In some embodiments, the lignin comprises technical lignin. As used herein, “technical lignin” refers to lignin that has been isolated from lignocellulosic biomass, for example, as a byproduct of a pulp and paper production or a lignocellulosic biorefinery. Technical lignins may have a modified structure compared to native lignin and may contain impurities depending on the extraction process. In some embodiments, the technical lignin comprises at least one of Kraft lignin, lignosulfonates, soda lignin, organosolv lignin, steam-explosion lignin, and enzymatic hydrolysis lignin. In other embodiments, the technical lignin may comprise any other form of technical lignin.

In embodiments where the lignin comprises lignosulfonates, the lignosulfonates may be in the form of a salt including, for example, sodium lignosulfonate, calcium lignosulfonate, or ammonium lignosulfonate.

In other embodiments, the technical lignin is in the form of unhydrolyzed Kraft black liquor. Black liquor is a byproduct of the Kraft process and may contain not only lignin but hemicellulose, inorganic chemicals used in the pulping process, and other impurities. In other embodiments, the technical lignin is in the form of “brown liquor” (also referred to as red liquor, thick liquor or sulfite liquor), which refers to the spent liquor of the sulfite process. In other embodiments, the technical lignin may be in the form of any other spent cooking liquor of a pulping process or any other suitable lignin-based byproduct.

In other embodiments, the lignin may be synthetic lignin or any other suitable type of lignin.

In some embodiments, the lignin is hydrolyzed. As used herein, “hydrolyze” refers to using acid or base hydrolysis at least partially to separate lignin from the polysaccharide content of the lignocellulosic biomass. For example, where the lignin is in the form of black liquor, carbon dioxide may be used to precipitate Kraft lignin from the black liquor and then the Kraft lignin may be neutralized with sodium hydroxide.

In some embodiments, the lignin is in an aqueous suspension. As used herein, an “aqueous suspension” of lignin refers to solid particles of lignin suspended, dispersed, and/or dissolved in a solvent that at least partially comprises water. In some embodiments, the solvent comprises substantially all water. In other embodiments, the solvent may comprise a combination of water and any other suitable solvent.

In some embodiments, the aqueous suspension of lignin may have a solids content of about 10% to about 75%, or about 30% to about 60%, or about 33% to about 55%. In some embodiments, the aqueous suspension of lignin may have a solids content of about 10% or above, or of about 25% or above, or of about 30% or above, or of about 33% or above. In some embodiments, the aqueous suspension of lignin may have a solids content of about 75% or below, or of about 60% or below, or of about 55% or below. In some embodiments, the aqueous suspension has a solids content of about 46%. A solids content of about 33% to about 55% allows the composition to be flowable, which facilitates flow through the treatment apparatus.

In some embodiments, the lignin comprises at least one of lignin nanoparticles and lignin microparticles. As used herein, “nanoparticle” refers to a particle in the nanometer size range, for example, between about 1 nm and about 1000 nm (1 μm), and “microparticle” refers to a particle in the micrometer size range, for example, between about 1 μm and about 1000 μm (1 mm). In some preferred embodiments, the lignin nanoparticles have a size of about 200 nm or less, or about 100 nm or less.

The lignin nanoparticles and/or microparticles can be produced by any suitable method. For example, the lignin nanoparticles and/or microparticles can be produced using at least one of: solvent shifting; pH shifting; cross-linking polymerization; mechanical treatment; ice-segregation; template based synthesis; aerosol processing; electro spinning; and carbon dioxide (CO₂) antisolvent treatment. Such methods are described in Beisl et al. “Lignin from Micro- to Nanosize: Production Methods” Int. J. Mol. Sci. 2017; 18:1244, incorporated herein by reference in its entirety.

In some preferred embodiments, lignin nanoparticles are produced using a pH shifting method, for example, as disclosed in Beisl et al. Briefly, the starting lignin material may be dissolved in a basic solution (e.g. an aqueous NaOH solution at pH 12) and the pH of the solution may be gradually decreased by addition of acid (e.g. HNO₃) to precipitate lignin nanoparticles. The solution may then be neutralized (e.g. by addition of NaOH) to re-suspend the nanoparticles. The resulting nanoparticles may have a size of about 200 nm or less, or about 100 nm or less. In other embodiments, the lignin nanoparticles may be produced by any other suitable method.

By providing the lignin in the form of lignin nanoparticles and/or microparticles, the surface area of the lignin is increased, thereby also increasing the negative force around each particle. In addition, lignin nanoparticles and/or microparticles may have improved solubility in water. Conventional lignins are typically only soluble in water at alkaline pH; however, nanoparticles and/or microparticles may be soluble in approximately neutral water (Beisl et al.), which may be preferred for some applications.

In some embodiments, where the lignin comprises an aqueous suspension of lignin nanoparticles, the zeta potential value of the suspension may be about −5 to about −80 mV. In some embodiments, the specific gravity of the aqueous suspension of lignin nanoparticles is between about 1.286 to about 1.7 SG.

The composition may further comprise at least one isolated strain of bacteria capable of biosurfactant production. As used herein, “isolated” or “isolate”, when used in reference to a strain of bacteria, refers to bacteria that have been separated from their natural environment. In some embodiments, the isolated strain or isolate is a biologically pure culture of a specific strain of bacteria. As used herein, “biologically pure” refers to a culture that is substantially free of other organisms.

As used herein, “biosurfactant” refers to compounds that are produced at the bacterial cell surface and/or secreted from the bacterial cell and function to reduce surface tension and/or interfacial tension. Non-limiting examples of biosurfactants include lipopeptides, surfactin, glycolipids, rhamnolipids, methyl rhamnolipids, and viscosin, for example. The isolated strain may be capable of producing one or more types of biosurfactant.

In some embodiments, the isolated strain may produce one or more additional active compounds. For example, the isolated strain may produce a biopolymer, solvent, acid, exopolysaccharide, and the like.

In some embodiments, the at least one isolated strain of bacteria comprises a strain of Bacillus. In other embodiments, the at least one isolated strain comprises a strain of bacteria capable of biosurfactant production and that is non-pathogenic. Non-limiting examples of suitable strains are listed in Satpute et al. “Methods for investigating biosurfactants and bioemulsifers: a review” Critical Reviews in Biotechnology, 2010, 1-18. For example, the at least one isolated strain of Bacillus may be Bacillus amyloliquefaciens, Bacillus licheniformis, Bacillus pumilus, Bacillus subtilis, or combinations thereof.

In some embodiments, the pH of the composition may be selected or adjusted to provide a suitable pH for the isolated strain(s). In some embodiments, the composition may further comprise one or more nutrients to support growth of the bacteria such as, for example, acetate, one or more vitamins, and the like.

In some embodiments, the isolated strain is in a viable form. For example, in some embodiments, the isolated strain may be in the form of a liquid suspension. In some embodiments, the isolated strain may be incubated for a suitable period of time prior to incorporation into the composition such that at least a portion of biosurfactant(s) is/are secreted into the bacterial suspension and therefore can be incorporated into the composition. For example, the bacteria can be incubated/fermented for between about one day and about six months or longer. The isolated strain may be incubated in the presence of a nutrient source and under suitable conditions (e.g. temperature, agitation, etc.) to produce the biosurfactant(s).

In other embodiments, the isolated strain may be in a lyophilized (freeze-dried) form. In some embodiments, the freeze-dried form comprises freeze-dried spores.

In some embodiments, where the isolated strain is in the form of a liquid suspension or in a freeze-dried form, the composition may comprise approximately 40 billion CFU (colony forming units) and may be combined with at least about 1 g of lignin and up to several tons of lignin.

In other embodiments, the isolated strain may be in an inviable form. For example, the isolated strain may be in the form of heat-killed cells or a cell lysate. In these embodiments, the bacteria of the isolated strain may be incubated for a suitable period of time prior to loss of viability (e.g. heat killing or lysis) such that a sufficient quantity of biosurfactant(s) is/are secreted into the bacterial suspension for incorporation into the composition. For example, the bacteria may be incubated for at least one week prior to loss of viability.

In other embodiments, a liquid suspension of bacteria may be incubated to produce the biosurfactant(s) and a supernatant containing the biosurfactant(s) may be separated from the bacterial cells and used in the composition.

Without being limited by theory, it is believed that the combination of lignin and the biosurfactant produced by the isolated strain act to mimic the natural habitat of the biosurfactant producing strains. The lignin may function as a growth substrate that contains required nutrients (carbon and fructose) to support growth of the bacteria, with the exception of additional acetate and metallic vitamins, which may be added to the composition as needed.

In some embodiments, the composition further comprises at least one of a carboxylic acid or a salt or ester thereof. In some embodiments, the carboxylic acid is a di-carboxylic acid or a salt or ester thereof. The carboxylic acid or salt/ester thereof may function as a solvent, for example, by facilitating formation of a stable emulsion of the various components of the composition. In some embodiments, the composition comprises a carboxylic acid ester. In some embodiments, the carboxylic acid ester comprises a methyl ester or a butyl ester. In some embodiments, the butyl esters are produced by biochemical metathesis. In some embodiments, the butyl ester comprises n-Butyl 4-oxopentanoate. In some embodiments, the methyl ester comprises unsaturated C₁₀ or C₁₂ methyl ester. In some embodiments, the methyl ester comprises methyl 9-decenoate or methyl 9-dodecenoate. In some embodiments, the methyl ester is produced from a plant oil feedstock.

In some embodiments, the composition further comprises carbon black. The carbon black may be electroconductive carbon black and the carbon black may function to increase the conductivity of the composition. In some embodiments, the carbon black may be conductive, superconductive, extraconductive or ultraconductive carbon black. In some embodiments, the carbon black may be in the form of carbon black beads, microparticles, and/or nanoparticles. For example, the carbon black may comprise Printex™ XE2 B Beads from Orion Engineered Carbons™. In some embodiments, the composition may comprise about 0.5% to about 10% carbon black by volume. In some embodiments, addition of carbon black may increase the negative zeta potential of the composition thereby increasing its electrical stability. In other embodiments, the composition may comprise any other highly conductive microparticle and/or nanoparticle.

In some embodiments, the composition may comprise about 1% to about 30%, or about 1% to about 20%, or about 1% to 10% of di-carboxylic acid and/or butyl esters by volume.

In some embodiments, the composition may comprise a catholyte solution, typically from about 1% to about 75% by volume of the catholyte solution.

It has surprisingly been found that the system of the invention can stabilize or upgrade an otherwise unstable catholyte solution. Accordingly, in some embodiments, the catholyte solution is pre-treated in the system of the invention for incorporation into a composition of the invention.

Accordingly, in some embodiments, the catholyte solution is upgraded prior to blending with the other components of the treatment composition. Such upgrading, as with many of the other fluids to be treated, may take place over treatment running times of between 5 min and 5 hours, depending on the particular application.

In some embodiments, the catholyte solution and other components of the treatment composition and/or the hydrocarbon containing material are blended, and the blended product is run through the treatment system.

In some embodiments, the composition is treated in the treatment system prior to being mixed with the hydrocarbon-containing material in order to aerate or gasify it. As used herein, “gasified” refers to introduction of a gas into the composition such that bubbles of the gas are suspended therein. The term “aerated” refers to gasifying with air or oxygen. The gas may be selected based on the aerobic or anaerobic nature of the isolated strain(s) incorporated into the composition. In some embodiments, the gas at least partially comprises oxygen. For example, the gas may be air or relatively pure oxygen. In some embodiments, the gas may at least partially comprise carbon dioxide and/or nitrogen. Gasification may function to provide oxygen and/or other suitable gasses directly or in close proximity to the bacterial cells of the isolated strain. Gasification may promote proliferation of the bacterial cells and allow the composition to be used or stored for an extended period of time. In some embodiments, the aerated composition may have a half-life of about 20 to 30 days.

The treatment system disclosed herein may be useful for various separation and recovery applications in the processing of hydrocarbons including, for example, hydrocarbon separation, demulsification of oil-in-water emulsions, and separation from particulate matter.

In some embodiments, the composition may comprise any other suitable components. For example, in some embodiments, the composition may further comprise at least one nutrient source for the live bacteria of the isolated strain.

Therefore, in some embodiments, a relatively non-toxic, inert, and sustainable composition is used in the treatment system for hydrocarbon separation. The composition may also be relatively low cost as lignin is a waste product of pulp and paper operations that is typically discarded.

The combination of the lignin-based separation composition with the respective treatment apparatus in the system, provides for enhanced separation and recovery of hydrocarbons from hydrocarbon containing materials.

As previously noted, the system may be used in the preparation of a lignin-based treatment composition prior to its use in the disclosed separation application, or any other application to which the lignin-based treatment composition is suited. It can also be used in treating a catholyte solution prior to its incorporation into the lignin-based treatment composition.

Various modifications besides those already described are possible without departing from the concepts disclosed herein. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Although particular embodiments have been shown and described, it will be appreciated by those skilled in the art that various changes and modifications might be made without departing from the scope of the disclosure. The terms and expressions used in the preceding specification have been used herein as terms of description and not of limitation, and there is no intention in the use of such terms and expressions of excluding equivalents of the features shown and described or portions thereof.

1. A system for treating a fluid, the system comprising:
a first treatment apparatus comprising an inlet and an outlet and defining a first treatment chamber between the inlet and the outlet, the inlet being in fluid communication with a source of the fluid, the first treatment chamber including means for disturbing the flow profile of fluid received from the source and flowing through the chamber, thereby to condition the fluid for further treatment;
a second treatment apparatus comprising an inlet and an outlet and defining a second treatment chamber between the inlet and the outlet, the inlet being in fluid communication with the first treatment apparatus to receive the conditioned fluid, the second treatment apparatus further comprising a nano-bubble generating device to form nano-bubbles in the fluid as it flows through the second treatment chamber prior to being expelled via the outlet; and
a pump arranged to cause the flow of the fluid through the respective first and second treatment apparatus.

2. A system according to claim 1, wherein the first treatment apparatus comprises a static mixer having a helical or spiral element along the length of the first treatment chamber, the element being arranged to create vortices in the flowing fluid.

3. A system according to claim 1, wherein the first treatment apparatus comprises a static mixer having a helical or spiral groove cut into an inner surface of the treatment apparatus defining the treatment chamber, the groove being arranged to create vortices in the flowing fluid.

4. A system according to any one of claims 1 to 3, wherein the pump is a vacuum pump in fluid communication with the outlet of the second treatment apparatus.

5. A system according to any one of claims 1 to 4, wherein the fluid is a composition comprising lignin and/or a hydrocarbon containing material.

6. A system according to claim 5, wherein the hydrocarbon-containing material is mixed with a composition comprising lignin prior to being treated in the system.

7. A system according to claim 5 or 6, wherein the lignin is technical lignin.

8. A system according to claim 7, wherein the technical lignin comprises at least one of Kraft lignin, lignosulfonates, soda lignin, organosolv lignins, steam-explosion lignin, enzymatic hydrolysis lignin, or unhydrolyzed Kraft black liquor lignin.

9. A system according to any one of claims 5 to 8, wherein the lignin is in an aqueous suspension.

10. A system according to any one of claims 5 to 9, wherein the lignin comprises at least one of lignin nanoparticles and lignin microparticles.

11. A system according to any one of claims 5 to 10, wherein the composition comprising lignin further comprises at least one isolated strain of bacteria capable of producing at least one biosurfactant, prior to being pumped through the respective first and second treatment apparatus

12. A system according to claim 11, wherein the at least one isolated strain comprises at least one isolated strain of Bacillus.

13. A system according to claim 12, wherein the at least one isolated strain of Bacillus is selected from the group consisting of Bacillus amyloliquefaciens, Bacillus licheniformis, Bacillus pumilus, Bacillus subtilis, and combinations thereof.

14. A system according to any one of claims 5 to 13, wherein the composition comprising lignin further comprises at least one of a carboxylic acid or a salt or ester thereof, such as a methyl ester or a butyl ester, or a di-carboxylic acid or a salt or ester thereof.

15. A system according to any one of claims 5 to 14, wherein the composition comprising lignin further comprises carbon black.

16. A system according to any one of claims 1 to 4, wherein the fluid is a catholyte solution, or according to any one of claims 5 to 15, wherein the composition comprising lignin further comprises a catholyte solution.

17. A system according to any one of claims 5 to 16, wherein the composition and/or catholyte solution, as the case may be, is treated in a system according to any one of claims 1 to 4.
